(19) United States
(12) Patent Application Publication
(10) Pub. No.: US 2024/0034548 A1
(43) Pub. Date: Feb. 1, 2024

(54) CAPSULE, METHOD AND SYSTEM FOR PREPARING A BEVERAGE

(71) Applicant: Delica AG, Buchs (CH)

(72) Inventors: Roland AFFOLTER, Möriken (CH); Markus BRÖNNIMANN, Hermrigen (CH); Olivia KURTZ, Zürich (CH); Caroline SIEFARTH, Basel (CH); Kathrin STEINBRÜCKNER, Birsfelden (CH); Tim THILLA, Weil am Rhein (DE); Patrick TSCHOPP, Riehen (CH); Martin WÜTHRICH, Ziefen (CH); Micha ZWEIFEL, Zürich (CH)

(73) Assignee: Delica AG, Buchs (CH)

(21) Appl. No.: 18/258,703

(22) PCT Filed: Dec. 20, 2021
(86) PCT No.: PCT/EP2021/086816

§ 371 Date: Jun. 21, 2023

(30) Foreign Application Priority Data
Dec. 22, 2020 (EP) 20216258.2

(51) Int. Cl. B65D 85/804; B65D 65/46; A47J 31/40; A23F 5/26

(52) U.S. Cl. CPC B65D 85/8043; B65D 65/466; A47J 31/407; A23F 5/262

(57) ABSTRACT

The invention relates to a capsule (1) for preparing a beverage, comprising—a core material (3) having a pressed product and—a shell (2) enclosing the core material, the capsule (1) having in a breaking strength test a maximum percentage expansion of at least 15% in a direction transverse to a pressing direction.

The present invention relates to a capsule, a method and a system for preparing a beverage, in particular a hot beverage, having the features of the generic concept of the independent claims.

The provision of a luxury food such as coffee in capsule form is well known. However, the materials usually used as shell material, such as plastics or aluminum (see e.g. EP 0 468 079 A1), have the disadvantage that they can usually only be recycled with great effort and are usually not compostable.

Capsules made of compostable materials or those with a filter paper as shell are also known. For example, DE 10 2018 201 187 B3 discloses a capsule made of a wood material compounded with bioplastic. The problem with capsules made of compostable materials lies in their processing. Although these capsules can be manufactured using injection molding technology, depending on the material used, dimensional accuracy is difficult to ensure due to the high fiber content. In particular, sealing contours, which enable the preparation of a beverage under high pressure, are difficult to form with low tolerances.

It is the task of the invention to overcome the disadvantages of the prior art. In particular, a capsule and a method for preparing a beverage are to be provided, in which an optimal seal is also made possible with compostable materials as well as different capsule sizes and capsule geometries.

This task is solved by the devices, methods and system defined in the independent patent claims. Further embodiments result from the dependent patent claims.

A capsule according to the invention for preparing a beverage, in particular a hot beverage, has a core material for preparing the beverage, comprising a compact or a bulk material, and a shell enclosing the core material. The core material may be selected from the group consisting of coffee powder, tea, cocoa, drinking chocolate, milk powder, instant coffee, and dry soup, and combinations thereof. According to the invention, the capsule has, in particular after wetting or rinsing with water, in a breaking strength test, a maximum percentage expansion in a direction transverse to a pressing direction relative to the original state of at least 15%, in particular at least 20%, preferably at least 25%, particularly preferably at least 30%.

For the breaking strength test, the capsule is positioned between two parallel plates of a tensile-compression testing machine (for example equipped with an Xforce P load cell from Zwick/Roell). The capsule is aligned centrally on the lower plate in the direction of extraction, or in the direction of compression in the case of a rotationally symmetrical compact, for example with a spherical or cube shape. The plates have a diameter at least 50% larger than the maximum capsule diameter. The parallel plates are slowly moved together and a force-displacement diagram is recorded. The load is increased until the shell is damaged. Simultaneously with this tearing or rupture, a drop in force is noted. When the measured force drops below the force drop threshold of 40% of the maximum force, the breaking strength test is terminated. The maximum measured force without damage to the shell is output as the breaking strength. In the case of a multi-layered shell, damage or a tear through the shell down to the core material is understood as damage to the shell. At the same time, the expansion of the capsule is recorded in a direction transverse to the pressing direction, i.e. in the direction parallel to the plates. The recording of the expansion in the transverse direction is recorded visually. Any flange of the capsule shell is not taken into account when recording the expansion. The expansion is recorded in two mutually perpendicular directions. An average value is formed from the two measured values. The maximum expansion transverse to the pressing direction is determined at the maximum force without damage, i.e. at the breaking strength. If the capsule is not damaged by a force of 600 N, the maximum expansion is determined at a force of 600 N.

Depending on the design of the shell, its deformability can be influenced by wetting or rinsing with water. For example, before carrying out the breaking strength test, the capsule can be immersed in a water bath at a temperature of 75° C. for 5 s and kept under water. The water is depressurized during this process. The capsule is in a wet state after such wetting or rinsing.

Such deformability ensures that the capsule can conform to the shape of the brewing chamber when the brewing chamber is closed or when a brewing liquid, typically hot water, is introduced. It can be ensured that the capsule fits tightly against the walls of the brewing chamber and that the entire amount of brewing liquid can be passed through the capsule. Poor quality of the prepared beverage due to leakage along the outside of the capsule can be prevented.

The core material can, for example, be present as loose bulk material. It is also conceivable that the bulk material is compacted, agglomerated or pressed into a compact by an upstream process. The core material can be composed of several parts.

The shell can also be single- or multi-part. For example, the shell can be manufactured separately and then filled with the core material and sealed. However, the shell can also be applied to the core material in liquid form, for example by spraying, dipping, or similar known processes.

The capsule, in particular after wetting or rinsing with water, can absorb a maximum force in the breaking strength test, as described above, of at least 25 N, in particular at least 50 N, preferably at least 100 N.

A maximum force of 25 N or more can ensure that the capsule can be tightly enclosed and deformed in a brewing chamber without being damaged. Even if the capsule is oversized relative to the brewing chamber, for example in one direction, the capsule can be tightly enclosed between two brewing chamber halves without damage to the shell so that a beverage can be prepared. If the core material is in the form of a compact, it can thus be deformed and broken open without damaging the shell. Optimum extraction is ensured.

The capsule can absorb a maximum force of at least 10 N, in particular at least 15 N, preferably at least 20 N, in a dry state without damage to the shell in a breaking strength test as described above.

Dry” or “in dry condition” means that the capsule has not yet come into contact with water or other liquids. In this state, the capsule is delivered and preferably inserted by the user into a beverage preparation machine.

A maximum force of at least 10 N for capsules in the dry state ensures that the capsule can be gripped by a user without special precautions and fed to a beverage preparation machine without the capsule breaking.

The capsule can have a burst pressure of less than 5 bar when wet.

The burst pressure is the internal pressure required to burst the capsule shell if the capsule shell is not supported. To determine the burst pressure, the capsule is immersed in water at an initial temperature of 75° C. for 180 min. The water drops to room temperature during the immersion period. It must be ensured that the capsule is completely covered with water. If necessary, it must be held under water.

If the core material of the capsule is a compact, it must be loosened up. For this purpose, the capsule is subjected to an upsetting treatment after immersion in water. The capsule is upset in all three dimensions by 5 mm each at a speed of 50 ram/min. The capsule is rotated by 45° and again upset by 5 mm in all three dimensions. The capsule is then immersed in water at room temperature for a further 120 min. The shell must not be damaged during the upsetting treatment. If the compact does not break, there is a risk that the burst pressure cannot be determined correctly, as the pressure in the compact cannot be passed on to the shell.

To measure the burst pressure, the capsule prepared as described above is inserted between two horizontal parallel plates, the upper plate being equipped with an injection needle. The plates do not exert any pressure on the capsule, only the injection needle penetrates the shell of the capsule. The capsule is not supported apart from the two horizontal plates. The needle tip or the injection port of the needle protrudes at least 0.5 mm further than the thickness of the wet capsule shell from the upper plate. Room temperature water is introduced into the capsule through the injection needle, and the water pressure is continuously increased and monitored. The water pressure is increased until the capsule shell ruptures or bursts. The pressure required for rupture or bursting is the burst pressure.

The maximum increase in capsule volume when filling the capsule with water as described can be at least 15%, in particular at least 20%, preferably at least 25%, particularly preferably at least 30%, based on the initial volume, without damaging the shell. If the capsule is spatially confined, for example enclosed in a brewing chamber, a maximum pressure of 18 bar can be generated during filling without damaging the capsule shell.

The shell can encase the core material over the entire surface and/or with a positive fit. A full-faced shell can ensure that the shell is completely closed. The core material is thus protected from environmental influences. If the shell is form-fitted, gassing with inert gas can be dispensed with. Shelf life is extended without additional effort, and sustainability is improved by a minimal packing dimension, which allows for a smaller packing volume. The entire logistics from the manufacturer to the consumer can be optimized. The core material gives the shell the required mechanical stability through its supporting effect. This in turn simplifies handling. In addition, a form-fitting shell simplifies penetration of the shell by a piercing agent when the capsule is used in a corresponding beverage preparation machine.

The core material can be compacted. By compacting, the amount of core material can be increased while the volume remains the same. The costs for packaging the capsules and thus also the transport costs can be reduced. In particular, when the capsules are compacted into a compact, the entire handling from production to the end user is simplified, since, as a result, the shape of the capsule is always approximately the same. It has been shown that the end user associates a higher quality to a compact than to a soft form. If the core material is in the form of a compact, it should be ensured that the compact is loosened up before the beverage is prepared. This can ensure, for example, that no “channeling” occurs with coffee, but that the entire coffee bed is uniformly penetrated by water. The loosening of any pressed coffee can be carried out by the user. It is also conceivable that the loosening can be carried out in a beverage preparation machine.

The shell of the capsule can be hygroscopic, in particular so that its weight can increase by at least 10%, in particular by at least 50%, preferably by at least 100%, particularly preferably by at least 150%, when it is immersed in a water bath at 100° C. without pressure for 10 seconds. To determine the water uptake, 1 cm2 of the capsule shell is cut out and freed from core material before the sample is soaked for 10 s in water at 100° C. for 10 s. The water uptake is then determined. To remove water adhering to the shell, the sample is turned over 5 times on a piece of household paper. Due to the hygroscopic property of the shell, it absorbs water in a short time when wetted or rinsed. This is advantageous because it allows the capsule to dissolve more easily when it is composted. In addition, the deformability of the casing can be influenced, for example. The shell can then more easily adapt to an external shape, for example the brewing chamber.

The thickness of the shell in the dry state can be between 0.01 mm and 3.5 mm, in particular between 0.02 mm and 1.5 mm, preferably between 0.05 mm and 0.2 mm. It has been shown that a shell with this thickness has optimum properties. A thinner shell would break or burst more easily. A thicker shell would be more difficult to pierce, thus a capsule with a thicker shell would be more difficult to extract.

The shell may have a surface-adjusted Oxygen Transmission Rate (OTR) in units of cm3 per m2 per day per 0.21 bar of less than preferably less than 20, more preferably less than 10, most preferably less than 5. The OTR indicates the amount of oxygen diffused through the shell per unit area and time. Such OTR values can ensure that the freshness of the capsules can be guaranteed for at least three months after opening a package. The consumer can thus store the capsules for a certain period of time with the packaging open without any loss of quality.

The complete capsule can be home compostable according to the NF T 51-800 and AS 5810 certification programs. Home compostable” means that the material is at least home compostable according to the certification programs NF T 51-800:2015-11-14 (Plastics —Specifications for plastics suitable for home composting) and AS 5810:2010 (Biodegradable plastics—Biodegradable plastics suitable for home composting). This means a decomposition (biodegradation) of at least 90% of the material with release of CO₂ within 12 months at a temperature of 25±5° C. as well as a fragmentation (disintegration) of at least 90% of the material within 6 months at a temperature of 25±5° C. The capsule can thus be handed over for composting after use. No separate disposal is necessary.

The shell of the capsule may comprise one or more of the following materials: PE, PP, natural rubber, silicone, polysaccharides or their derivatives, compounds of vegetable starch and fatty acids, polyvinyl alcohol, polyvinyl alcohol copolymer, nonwoven, proteins, aluminum, laminates, biodegradable plastics.

The capsule may have a round, in particular spherical, shape. However, it is also conceivable that the shape of the capsule corresponds essentially to other geometric bodies, such as a cube, cuboid, prism, pyramid, cylinder, truncated cone, cone, torus, ellipsoid, etc. It should be noted that any corners and edges are preferably not sharp but rounded.

Another aspect of the present invention relates to a capsule, particularly as described above, for use in a beverage preparation machine for preparing beverages. The beverage preparation machine includes a brewing chamber having a mold and a chamber volume for receiving the capsule. The brewing chamber has penetration means for piercing and introducing water into the capsule and perforation means for forming an outlet from the capsule. The capsule has a shape and a dry volume prior to the introduction of water into the capsule and a wet volume during the introduction of water. During the introduction of water, the wet volume of the capsule increases. The shell of the capsule is configured to be deformable such that the shape of the capsule is adaptable to the shape of the brewing chamber without damage to the shell, such that the maximum wet volume of the capsule during beverage preparation is substantially equal to the chamber volume of the brewing chamber.

The maximum wet volume is understood to be the maximum volume of the capsule enclosed in the brewing chamber which the capsule takes up during the introduction of water into the capsule. To determine the maximum wet volume, 200 ml of water is introduced into the capsule under a pressure of 6 bar at a flow rate of 200 ml/min.

The deformable design of the shell and the matching of the volume of the capsule to the chamber volume of the brewing chamber during the introduction of water into the capsule can ensure that the capsule and the brewing chamber are optimally matched. For example, it is not necessary for the volume of the capsule to match that of the brewing chamber even before the capsule is used. It is even conceivable that a capsule with a smallest diameter can be used, which is larger than a smallest diameter of the brewing chamber. Likewise, capsules with different sizes can be used with the same brewing chamber. For example, the capsule can thus be manufactured without adhering to tight tolerances and without sacrificing quality. The manufacturing costs can be reduced.

The wet volume of the capsule is adapted to the chamber volume of the brewing chamber without damaging the shell. Thus, after beverage preparation, the capsule as a whole can be removed from the brewing chamber without the core material contaminating the brewing chamber.

The wet volume can only be adapted to the chamber volume of the brewing chamber once a certain amount of water has been introduced. Usually, a ristretto is the smallest reference unit of a beverage made from capsules. A ristretto is usually prepared with 15-25 ml of water. The maximum wet volume is already reached with 10 ml of water, optionally with a subsequent pre-brewing pause of 5 s. The pressure is approx. 5 bar.

The maximum wet volume, i.e. the maximum volume of the capsule enclosed in the brewing chamber, which the capsule occupies during the introduction of water into the capsule, can be between 11% and 75%, in particular between 30% and 70%, preferably between 35% and 65%, greater than the dry volume. For the determination of the maximum wet volume, the volume of the capsule is determined without taking into account the penetration means that have penetrated into the capsule and without the perforation means that ensure the outlet. It has been shown that in the case of compacted core material, especially if this is in the form of a compact, an initial increase in volume already occurs when the compact is loosened in the capsule. A further increase in volume is based on the swelling of the core material when it comes into contact with water. Based on this swelling, there is already a volume increase of approx. 15% compared to the dry volume. As a result, the desired ingredients can be extracted more effectively. In addition, the above-mentioned volume increase up to the maximum wet volume can also ensure that, for example, no “channeling” occurs with coffee, but that the entire coffee bed is uniformly penetrated by water.

The shape of the capsule can essentially correspond to the shape of the brewing chamber after beverage preparation. Since the maximum wet volume of the capsule during beverage preparation essentially corresponds to the volume of the brewing chamber, the shape also adapts accordingly. After beverage preparation, the capsule is removed from the brewing chamber. If the core material does not dissolve and only swells due to contact with water, the shape is essentially not changed in the process. However, if the core material is at least partially a soluble substance, the shape of the capsule may no longer conform to the shape of the brewing chamber after beverage preparation due to the lack of support provided by the core material and may partially collapse. Depending on the properties of the shell, in particular its elasticity, the capsule may reduce its volume as soon as the water pressure of the incoming water decreases. However, it is equally conceivable that, in particular when the core material dissolves, the shell also dissolves completely. This means that no residue remains in the brewing chamber.

Another aspect of the present invention relates to a method of preparing a beverage using a capsule, in particular a capsule as described above. In this regard, the capsule has a dry volume prior to use thereof. The method comprises the following steps:
Inserting the capsule into an open brewing chamber,
Enclosing the capsule by closing the brewing chamber so that the brewing chamber defines a shape and volume,
Preparation of a beverage from the capsule by introducing water into the capsule, whereby the dry volume becomes a wet volume.

In the process, the capsule expands during beverage preparation. The shape and maximum wet volume of the capsule essentially conform the shape and volume of the brewing chamber.

The maximum wet volume can be between 11% and 75%, in particular between 30% and 70%, preferably between 35% and 65%, larger than the dry volume. It has been shown that in the case of compacted core material, especially if this is in the form of a compact, an initial increase in volume already occurs when the compact is loosened up. This loosening is partly based on the plastic and/or elastic deformation of the capsule when the capsule is enclosed, for example when the smallest diameter of the capsule is larger than the smallest inner diameter of the brewing chamber. Another volume increase is based on the swelling of the core material when it comes into contact with water. A further increase in volume, and thus a further expansion of the shell, occurs as a result of injecting water into the capsule and increasing the pressure. The volume of the capsule is increased until the shell is largely flush with the outer wall of the brewing chamber.

Depending on the design of the brewing chamber and the capsule, the capsule can be plastically and/or elastically deformed when the brewing chamber is closed. For example, loose core material can be compacted in such a way that uniform extraction through the core material takes place without the formation of channels.

The shape of the brewing chamber can have a smallest inner diameter, which is smaller than the smallest outer diameter of the capsule. Thus, the capsule already deforms when the brewing chamber is closed. If the core material is compacted or comprises a compact, this is already loosened when the brewing chamber is closed. The density of the core material enclosed in the shell is reduced. It can be ensured that the water can pass through the core material when it is introduced. Over- or under-extraction can thus be avoided and it is ensured that the core material comes into uniform contact with the water.

Before water is introduced into the capsule, the capsule can be wetted or rinsed with water. Depending on the design of the shell, its deformability can be influenced by wetting or rinsing with water. For example, the chamber can be flooded with 5-15 ml of water at a temperature of 80-100° C. for 1-10 s. The water is then flushed into the chamber without pressure. For this purpose, the water is introduced into the chamber without pressure and then discharged again via an outlet. However, the capsule can also be wetted or rinsed with water before it is inserted into the brewing chamber or before the brewing chamber is closed. It goes without saying that the rinsing water required for wetting or rinsing cannot be routed to the beverage outlet of the machine but should be discharged separately from it.

Another aspect of the present invention relates to a system comprising a capsule, particularly as previously described, and a beverage preparation machine. The beverage preparation machine has a brewing chamber having a shape and a volume for receiving the capsule. The brewing chamber has penetration means for piercing and introducing water into the capsule, and perforation means for forming an outlet from the capsule. The capsule has a shape and a dry volume prior to the introduction of water and a wet volume during the introduction of water. In this regard, the shell of the capsule is configured to be expandable such that the shape of the capsule is substantially conformable to the shape of the brewing chamber such that the maximum wet volume of the capsule is substantially equal to the volume of the brewing chamber.

The fact that the capsule can adapt its shape and volume to the brewing chamber during the introduction of water means that the capsule and brewing chamber do not have to match exactly on the production side. It can be manufactured with relatively large tolerances. Nevertheless, an optimal sealing of the capsule in the brewing chamber can take place so that no water flows outside the capsule from the inlet to the outlet of the brewing chamber.

Adjusting the wet volume of the capsule to the volume of the brewing chamber can be done without damaging the shell. Thus, after beverage preparation, the capsule as a whole can be removed from the brewing chamber without the core material contaminating the brewing chamber.

The wet volume can be between 11% and 75%, in particular between 30% and 70%, preferably between 35% and 65%, larger than the dry volume. An increase in volume is useful for coffee, for example, to allow for swelling of the coffee. It is also advantageous if compacted coffee powder can loosen up so that uniform extraction can take place.

The shape of the brewing chamber can have a smallest inner diameter, which is smaller than the smallest outer diameter of the capsule. This configuration favors loosening, especially in the case of a pressed product, for example a coffee powder pressed product, so that optimum extraction can take place.

### EXAMPLE

A spherical compact for coffee preparation was prepared by compacting 6 g of roasted ground coffee powder. Subsequently, an aqueous solution of demineralized water, cellulose (VITACEL Cellulose, JRS, Germany) and sodium alginate (VIVAPUR Sodium Alginate, medium viscosity, JRS, Germany) was prepared. A system was prepared in the form of an aqueous solution with a concentration of cellulose of 1.0% and sodium alginate of 1.7% w/w based on the total weight of the aqueous solution. Subsequently, 3.5% w/w sorbitol was added to the solution, based on the total weight of the system. In parallel, an aqueous solution of demineralized water and 5.0% w/w calcium chloride (calcium chloride dihydrate, C. Roth, Germany) was prepared. The compact was first immersed in the aqueous cellulose-containing sodium alginate solution for 10 s, then in the aqueous calcium chloride solution for 30 s and dried in an air stream at 50° C. for about 8 min. Subsequently, the compact was immersed a second time for 10 s in the aqueous cellulose-containing sodium alginate solution, then immersed for 30 s in the aqueous calcium chloride solution and dried for at least 8 min at 50° C. in an air stream.

Ten capsules prepared in this way were immersed in a water bath at a temperature of 75° C. for 5 s and held under water. The water was depressurized during this process. Subsequently, the maximum expansion of the capsule was determined in the breaking strength test. A maximum expansion of at least 53% was measured.

Another ten samples were extracted in a brewing chamber, where the volume of the brewing chamber was 45% larger than the dry volume of the capsules. The capsules could be removed from the brewing chamber as a whole after extraction. The shell was not damaged and the brewing chamber was accordingly not contaminated.

The invention is explained in more detail below with reference to figures, which are merely examples of embodiments. They show:

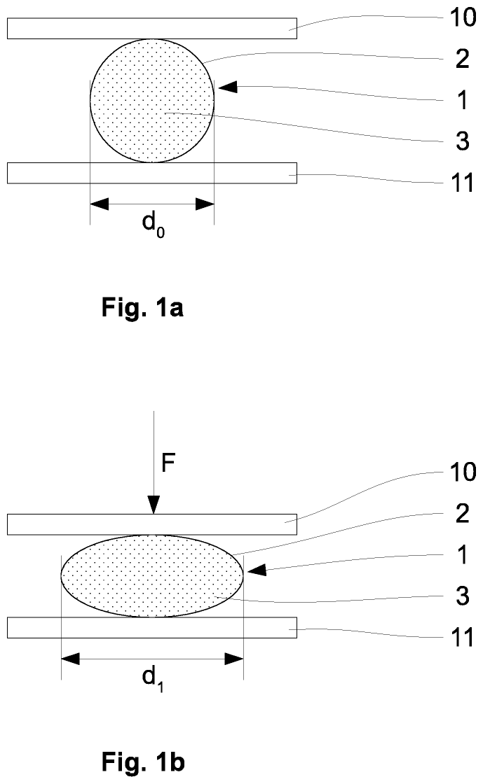

FIG. 1a: A schematic representation of a spherical capsule according to the invention in a device for breaking strength testing.

FIG. 1b: The representation from FIG. 1a, with a force acting on the capsule.

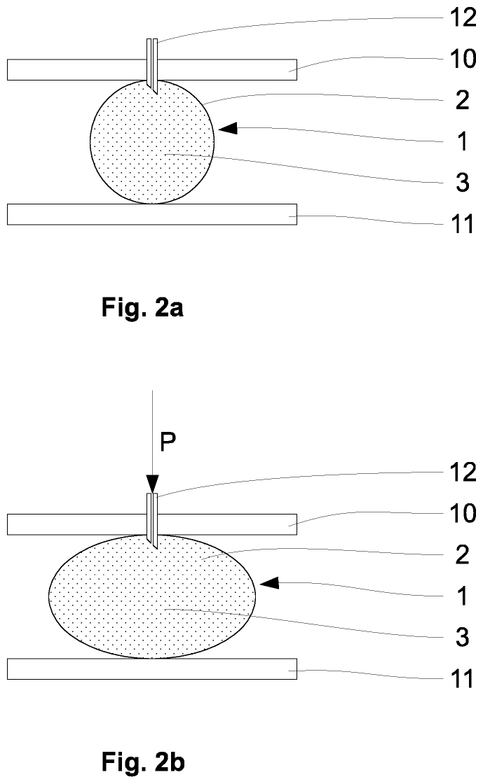

FIG. 2a: A schematic representation of a spherical capsule according to the invention in a device for determining the burst pressure.

FIG. 2b: The representation of FIG. 2a, where water is introduced into the capsule at a pressure.

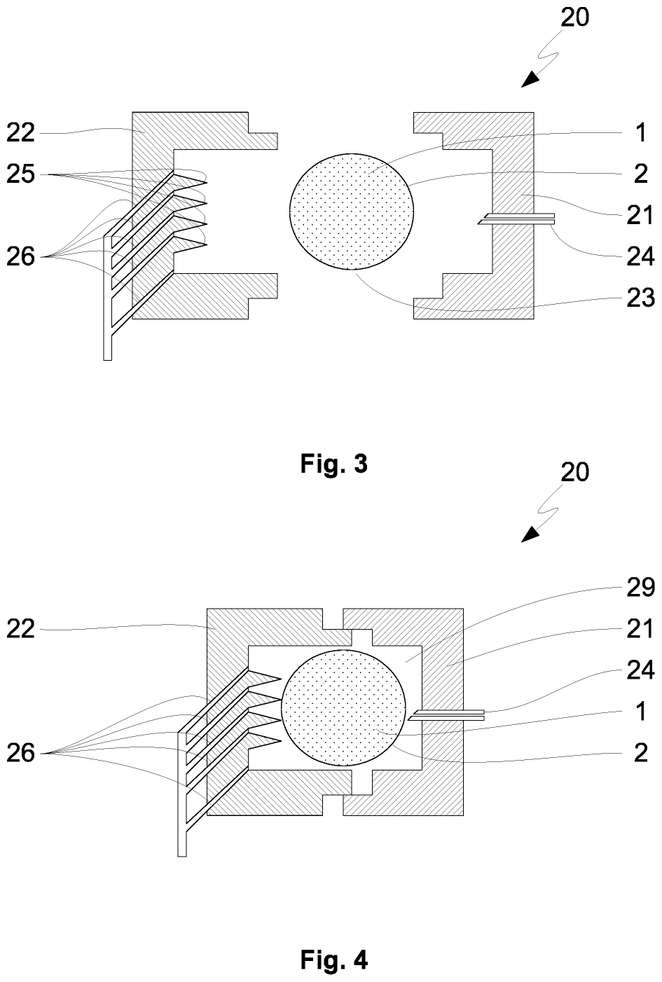

FIG. 3: A schematic representation of an open brewing unit with the capsule of the invention already inserted, prior to beverage preparation.

FIG. 4: A schematic representation of the brewing unit of FIG. 3 in a first closed position with the capsule of the invention inserted.

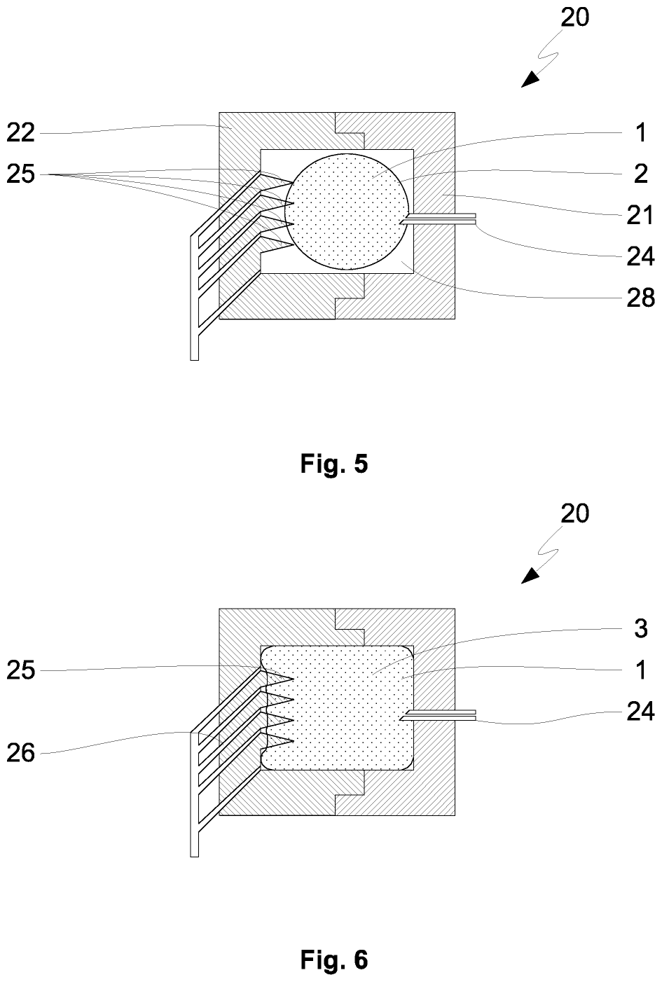

FIG. 5: A schematic representation of the brewing unit of FIG. 3 in a second closed position with the capsule of the invention inserted.

FIG. 6: A schematic representation of the brewing unit of FIG. 5, during beverage preparation.

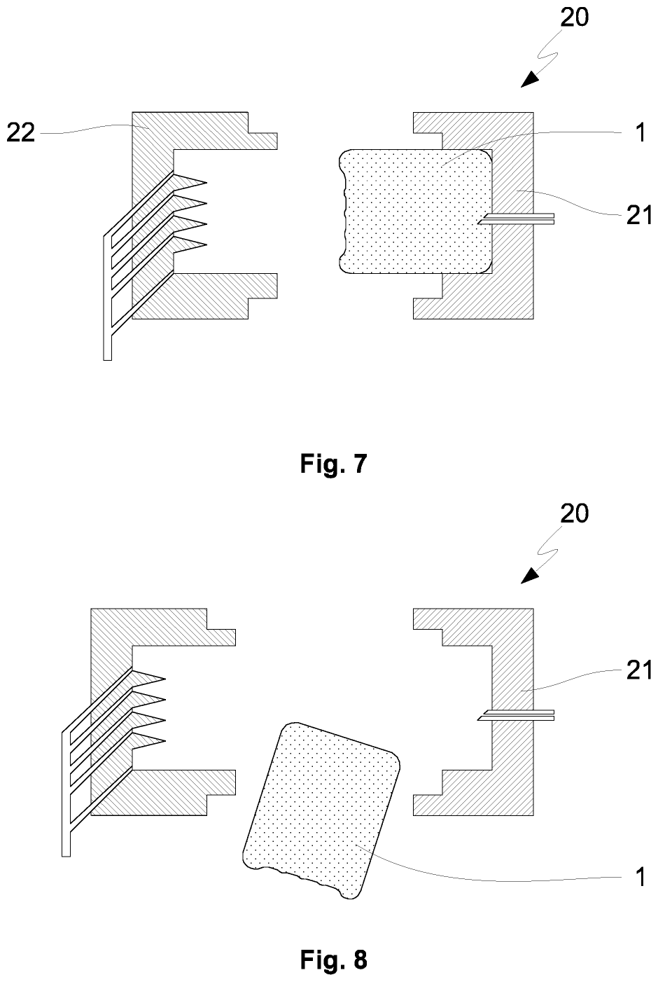

FIG. 7: A schematic representation of an open brewing unit with capsule according to the invention after beverage preparation.

FIG. 8: A schematic representation of an open brewing unit during capsule ejection after beverage preparation.

FIG. 1a shows a schematic representation of a spherical capsule 1 according to the invention in a breaking strength test device. The breaking strength test device has a lower plate 11 or carrier plate and an upper plate 10. The two plates are aligned horizontally and parallel to each other and are part of a tensile compression test apparatus not shown. The capsule 1 has a shell 2 and a core material 3 enclosed thereby. The capsule 1 has an outer dimension do without force parallel to the plates 10, 11. The capsule 1 is placed on the lower plate 11 approximately in the center. The upper plate 10 rests without force on the shell 2 of the capsule 1.

To determine the maximum force of the capsule 1 in the breaking strength test, the upper plate 10 is slowly lowered by means of the tension-compression test apparatus and a force-displacement diagram is recorded. FIG. 1b shows how the upper plate 10 acts with a force F on the capsule 1. Due to the acting force F, the capsule 1 deforms by expanding in a direction transverse to the acting force F. The outer dimension d₁ becomes larger as the force F increases. The expansion in the transverse direction to the acting force F is continuously recorded visually. The maximum expansion of the capsule 1 in the direction transverse to the acting force F is reached when the shell 2 of the capsule 1 is damaged. The capsule 1 shown can expand in the direction transverse to the applied force F by 30% compared with its original outer dimension do, i.e. the outer dimension d₁ is 30% greater than the original outer dimension d₀. Only when this outer dimension d1 is exceeded does the shell 2 of the capsule 1 tear open. The force F required for this is 120 N.

FIG. 2a shows a schematic representation of a spherical capsule 1 according to the invention in a device for determining the burst pressure. The device for determining the burst pressure again has a lower plate 11 or carrier plate and an upper plate 10. The two plates are aligned horizontally and parallel to each other. The upper plate 10 also has an injection needle 12 through which water at room temperature can be introduced into the capsule. Between the two plates 10, 11 is the capsule 1. Here, the capsule 1 again has a shell 2 and a core material 3 enclosed by the shell. The shell 2 of the capsule 1 is pierced by the injection needle 12, which protrudes 2 mm from the upper plate. The plates 10, 11 do not exert any pressure on the capsule 1 FIG. 2b shows how water at room temperature is introduced into the capsule 1 through the injection needle 12. For this purpose, the injection needle 12 is connected to a pump (not shown). In addition, the pressure P of the injected water is continuously measured by means of a manometer (not shown). The water pressure is increased until the shell 2 of the capsule 1 rips or bursts.

The pressure P required for the rupture or bursting of the shell 2 is the bursting pressure.

FIGS. 3 to 8 show schematically the individual steps in the preparation of a beverage with a capsule 1 according to the invention and a beverage preparation machine. The same components are shown in different positions in each case.

FIG. 3 shows an open brewing unit 20 of the beverage preparation machine with the capsule 1 according to the invention already inserted before the beverage preparation. The brewing unit is formed by two parts separated from each other, a first brewing chamber half 21 and a second brewing chamber half 22. It goes without saying that the brewing unit 20 can also be assembled from more than two parts. An inlet opening for inserting the capsule 1 is formed between the two brewing chamber halves 21, 22.

The capsule 1 is arranged in a receiving position 23 of the first brewing chamber half 21. In this first brewing chamber half 21, a penetration means 24 is arranged in such a way that it protrudes from the wall of the first brewing chamber half 21, but when the capsule 1 is inserted into the receiving position 23, a shell 2 of the capsule 1 is not damaged.

The second brewing chamber half 22 has perforation means 25 in a side wall which can pierce the shell 2 of the capsule 1. However, they are not in contact with the capsule 1 when the brewing unit 20 is open. The side wall with the perforation means 25 has several outlet openings 26, which allow a prepared beverage to be drained off. These outlet openings 26 could also be used for draining residual water after beverage preparation or rinsing water. This residual water or rinse water is not directed to the beverage outlet of the machine.

FIG. 4 again shows a schematic representation of the brewing unit 20 from FIG. 3 in a first closed position. In this first closed position, the capsule 1 is enclosed in a flushing chamber 29 formed between the two brewing chamber halves 21, 22. In this position, water is introduced into the flushing chamber 29 by the penetration means 24 and the flushing chamber 29 is flooded. For example, 5-15 ml of water at a temperature of 80-100° C. may be used for this purpose. The outlet openings 26 are closed for the time being. The capsule 1 is flushed with water. If the capsule 2 is hygroscopic, it can change its properties by absorbing water. After an exposure time of 1-10 s, the outlet openings 26 can be opened and the rinsing chamber 29 emptied. It goes without saying that this rinse water should be drained separately and not be directed to the beverage outlet of the machine. It is also possible to use an outlet opening 26 specifically as a rinsing water outlet.

In FIG. 5, the brewing unit 20 is shown in a second closed position. The two brewing chamber halves 21, 22 have moved further together and form a closed chamber volume 28. The penetration means 24 and the perforation means 25 have penetrated the shell 2 of the capsule 1. The penetration means 24 can now introduce the amount of water required for beverage preparation into the capsule 1.

FIG. 6 shows a schematic representation of the brewing unit 20 from FIG. 5 during beverage preparation. Due to the water pressure and the swelling of the core material 3 of the capsule 1, this has expanded and fills the entire brewing chamber 28 (see FIG. 5). It goes without saying that sharp-edged corners or the spaces between the perforation means are not completely filled by the capsule 1. However, this has no influence on the function and quality of the prepared beverage. The water is now pressed through the capsule 1 starting from the penetration means 24 through the core material to the opening formed by the perforation means 25. Depending on the nature of the core material 3, it is extracted or dissolved to form a beverage. The prepared beverage may leave the capsule 1 through openings formed by the perforation means 25 and is discharged from the brewing chamber through the outlet openings 26. A separate rinse water outlet, if any, may be closed during beverage preparation or may remain open.

FIG. 7 shows a schematic diagram of the open brewing unit 20 with the capsule 1 according to the invention after preparation of the beverage. The two brewing chamber halves 21, 22 are moved apart so that the capsule 1 can relax.

FIG. 8 shows the ejection of the capsule 1 from the brewing unit 20. For this purpose, the brewing unit 20 can be opened further than in FIG. 7. To ensure that the capsule 1 is ejected, an ejector (not shown) can be used in a known manner, for example, which pushes the capsule 1 out of the first brewing chamber half 21 or at most the second brewing chamber half after the brewing unit 20 has been opened. Of course, other mechanisms for ejecting the capsule 1 are also conceivable. After the ejector has been moved back, the brewing unit can be returned to the position as shown in FIG. 3. Another capsule can be inserted.

1-15. (canceled)

16. A capsule for preparing a beverage, the capsule comprising:
a core material for beverage preparation comprising a compact,
and
a shell enclosing the core material,
wherein the capsule has, in a breaking strength test, a maximum percentage expansion in a direction transverse to a pressing direction of at least 15%.

17. The capsule according to claim 16, wherein the capsule absorbs a maximum force in the breaking strength test of at least 25 N.

18. The capsule according to claim 16, wherein the capsule in dry state absorbs a maximum force in a breaking strength test of at least 10 N.

19. The capsule according to claim 16, wherein the shell is hygroscopic, and the weight of the shell increases by at least 10% when immersed in a water bath at 100° C. without pressure for a period of 10 s.

20. The capsule according to claim 19, wherein the weight of the shell increases by at least 50% when immersed in a water bath at 100° C. without pressure during 10 s.

21. The capsule according to claim 20, wherein the weight increases by at least 100%.

22. The capsule according to claim 20, wherein the weight increases by at least 150%.

23. The capsule according to claim 16, wherein a thickness of the shell in dry state is between 0.01 mm and 3.5 mm.

24. The capsule according to claim 16, wherein the shell has a surface adjusted Oxygen Transmission Rate (OTR) of less than 50 cm³ per m² per day per 0.21 bar.

25. The capsule according to claim 16, wherein the complete capsule is home compostable according to at least one of the NF T 51-800 certification program and the AS 5810 certification program.

26. A capsule for use in a beverage preparation machine for beverage preparation, the beverage preparation machine having a brewing chamber including a mold and a chamber volume for receiving the capsule, the brewing chamber having penetration means for piercing and introducing water into the capsule and perforation means for piercing a shell of the capsule, wherein the capsule has a shape and a dry volume prior to the introduction of water and a wet volume upon the introduction of water, wherein the shell of the capsule is deformable such that the shape of the capsule is adaptable to the shape of the brewing chamber without damaging the shell, that the maximum wet volume of the capsule during beverage preparation substantially corresponds to the chamber volume of the brewing chamber.

27. The capsule according to claim 26, wherein the maximum wet volume is between 11% and 75% greater than the dry volume.

28. A method for preparing a beverage with a capsule, wherein the capsule has a dry volume, the method comprising:
inserting the capsule into an open brewing chamber,
enclosing the capsule by closing the brewing chamber so that the brewing chamber defines a shape and a chamber volume,
extracting a beverage from the capsule by introducing water into the capsule, whereby the dry volume becomes a wet volume,
wherein the capsule expands during beverage preparation and the shape and maximum wet volume of the capsule substantially conform to the shape and chamber volume of the brewing chamber.

29. The method according to claim 28, wherein the maximum wet volume is between 11% and 75% larger than the dry volume.

30. The method according to claim 28, wherein the capsule is plastically and/or elastically deformed when the brewing chamber is closed.

31. The method according to claim 28, wherein the shape of the brewing chamber has a smallest inner diameter, which is smaller than the smallest outer diameter of the capsule and the capsule already deforms when the brewing chamber is closed.

32. The method according to claim 28, wherein a compressed core material of the capsule is loosened when the brewing chamber is closed, so that the density of the core material enclosed in the shell is reduced.

33. A system comprising a capsule and a beverage preparation machine, said beverage preparation machine having a brewing chamber with a mold and a chamber volume for receiving said capsule, said brewing chamber having penetration means for piercing and introducing water into said capsule and perforation means for piercing a shell of said capsule, wherein the capsule has a shape and a dry volume before the introduction of water and a wet volume during the introduction of water, wherein the shell of the capsule is expandable such that the shape of the capsule is substantially adaptable to the shape of the brewing chamber so that the maximum wet volume of the capsule substantially corresponds to the chamber volume of the brewing chamber.

34. The system of claim 33 wherein the wet volume is at least 11% greater than the dry volume.

35. The system of claim 34 wherein the capsule is home compostable according to at least one of the NF T 51-800 certification program and the AS 5810 certification program.
